(19) United States
(12) Patent Application Publication
(10) Pub. No.: US 2025/0174040 A1
(43) Pub. Date: May 29, 2025

(54) DISPLAY APPARATUS AND METHOD OF DETECTING FINGERPRINT BY USING THE SAME

(71) Applicant: Samsung Display Co., Ltd., Yongin-si (KR)

(72) Inventor: Sangheon Ye, Yongin-si (KR)

(21) Appl. No.: 18/953,755

(22) Filed: Nov. 20, 2024

(30) Foreign Application Priority Data
Nov. 24, 2023 (KR) 10-2023-0165825

(51) Int. Cl. G06V 40/12; G06V 40/13

(52) U.S. Cl. CPC G06V 40/1359; G06V 40/1318

(57) ABSTRACT

A display apparatus includes: a display panel including a plurality of display pixels in which light-emitting elements are arranged, and a plurality of sensor pixels in which light-receiving elements are arranged; a memory configured to store a compensation coefficient for each of respective locations of the plurality of sensor pixels; and a sensor controller configured to correct a plurality of fingerprint data obtained from the plurality of sensor pixels, by using the compensation coefficient stored for each of the respective locations, to calculate a plurality of correction data.

### CROSS-REFERENCE TO RELATED APPLICATION

The present application claims priority to and the benefit of Korean Patent Application No. 10-2023-0165825, filed on Nov. 24, 2023, in the Korean Intellectual Property Office, the entire disclosure of which is incorporated herein by reference.

### BACKGROUND

### 1. Field

Aspects of one or more embodiments relate to a structure of a display apparatus, and a method of detecting a fingerprint by using the display apparatus.

### 2. Description of the Related Art

In general, display apparatuses include light-emitting elements, such as organic light-emitting diodes, and thin film transistors formed on a substrate, and the light-emitting elements are configured to emit light.

For example, each pixel of a display apparatus generally includes a light-emitting element, such as an organic light-emitting diode, in which an intermediate layer including an emission layer is between a pixel electrode and an opposite electrode. Display apparatuses generally control emission or non-emission of each pixel or the degree of light emission by each pixel, through a thin film transistor electrically connected to a pixel electrode. Some layers included in an intermediate layer of such a light-emitting element are commonly provided in a plurality of light-emitting elements.

The above information disclosed in this Background section is only for enhancement of understanding of the background and therefore the information discussed in this Background section does not necessarily constitute prior art.

### SUMMARY

Aspects of one or more embodiments include a display apparatus having relatively improved detection performance while realizing high-quality images, and a fingerprint detecting method using the display apparatus. However, aspects of embodiments according to the present disclosure are not limited thereto, and the above characteristics do not limit the scope of embodiments according to the present disclosure.

Additional aspects will be set forth in portion in the description which follows and, in part, will be apparent from the description, or may be learned by practice of the presented embodiments of the disclosure.

According to one or more embodiments, a display apparatus includes a display panel including a plurality of display pixels in which light-emitting elements are arranged, and a plurality of sensor pixels in which light-receiving elements are arranged, a memory storing a compensation coefficient for each of respective locations of the plurality of sensor pixels, and a sensor controller configured to correct a plurality of fingerprint data obtained from the plurality of sensor pixels, by using the compensation coefficient stored for each of the respective locations, to calculate a plurality of correction data.

According to some embodiments, the plurality of fingerprint data may be current values measured by the light-receiving elements respectively arranged in the plurality of sensor pixels that have detected light reflected by a user's fingerprint.

According to some embodiments, the plurality of fingerprint data may include, for each of the respective locations of the plurality of sensor pixels, high fingerprint data having a maximum value among pieces of data of the sensor pixel, and low fingerprint data having a minimum value among the pieces of data of the sensor pixel. According to some embodiments, the high fingerprint data and the low fingerprint data may have random values for each of the plurality of sensor pixels.

According to some embodiments, the high fingerprint data may be data about a valley of the user's fingerprint, and the low fingerprint data may be data about a ridge of the user's fingerprint.

According to some embodiments, each of the plurality of correction data may include high correction data obtained by correcting the high fingerprint data, and low correction data obtained by correcting the low fingerprint data. According to some embodiments, the high correction data may have a specific non-zero value for all of the plurality of sensor pixels, and the low correction data may have a value of 0 for all of the plurality of sensor pixels.

According to some embodiments, the sensor controller may include a data obtainer configured to generate the fingerprint data by using electrical signals input from the respective light-receiving elements of the plurality of sensor pixels, and a data processor configured to correct the fingerprint data by using the compensation coefficient to calculate the correction data.

According to some embodiments, the sensor controller may further include a fingerprint detector configured to detect a user's fingerprint by using the correction data.

According to some embodiments, the compensation coefficient may be a value calculated using high sensor data measured for each sensor pixel in a bright environment and low sensor data measured for each sensor pixel in a dark environment.

According to some embodiments, a value obtained by subtracting the low sensor data from the high sensor data is referred to as variation data, and the compensation coefficient of a specific sensor pixel among the plurality of sensor pixels may be a value obtained by dividing an average value of respective variation data of the plurality of sensor pixels by the variation data of the specific sensor pixel.

According to some embodiments, the data processor may calculate the correction data by using the compensation coefficient and a specific function, and the specific function may obtain the correction data by multiplying a value obtained by subtracting the low sensor data from the fingerprint data by the compensation coefficient.

According to one or more embodiments, a fingerprint detecting method using a display apparatus including a plurality of display pixels in which light-emitting elements are arranged, and a plurality of sensor pixels in which light-receiving elements are arranged includes calculating a compensation coefficient for each of respective locations of the plurality of sensor pixels and storing the compensation coefficient in a memory, generating fingerprint data for each of the plurality of sensor pixels in a use mode, and correcting the fingerprint data by using the compensation coefficient to calculate correction data for each of the respective locations of the plurality of sensor pixels.

According to some embodiments, the calculating of the compensation coefficient and the storing of the compensation coefficient in the memory may include obtaining high sensor data for the location of each of the plurality of sensor pixels in a first inspection mode and obtaining low sensor data for each of the respective locations of the plurality of sensor pixels in a second inspection mode. In the first inspection mode, an inspection may be performed in a bright environment, and, in the second inspection mode, an inspection may be performed in a dark environment.

According to some embodiments, the high sensor data may be measured with a reflector being placed on the display apparatus, which is to be inspected, and green light being turned on.

According to some embodiments, the low sensor data may be measured with a light-absorbing plate or a black box being placed on the display apparatus, which is to be inspected, and external light being blocked.

According to some embodiments, the high sensor data may be an average value of pieces of valid data excluding pieces of mis-measurement data that are outside an allowable range, after taking multiple pictures of the display apparatus, which is to be inspected, in the first inspection mode, and the low sensor data may be an average value of pieces of valid data excluding pieces of mis-measurement data that are outside an allowable range, after taking multiple pictures of the display apparatus, which is to be inspected, in the second inspection mode.

According to some embodiments, the calculating of the compensation coefficient and the storing of the compensation coefficient in the memory may further include calculating variation data by subtracting the low sensor data from the high sensor data, for each of the respective locations of the plurality of sensor pixels, and calculating an average value of the pieces of variation data of all of the plurality of sensor pixels.

According to some embodiments, the calculating of the compensation coefficient and the storing of the compensation coefficient in the memory may further include dividing the average value of the variation data by the variation data of each of the plurality of sensor pixels to calculate the compensation coefficient of each of the plurality of sensor pixels.

According to some embodiments, calculating the correction data may include correcting the fingerprint data by using the compensation coefficient and a specific function, and the specific function may obtain the correction data by multiplying a value obtained by subtracting the low sensor data from the fingerprint data by the compensation coefficient.

According to some embodiments, the fingerprint data may include high fingerprint data corresponding to valleys of the user's fingerprint, and low fingerprint data, which is data about the ridges of a user's fingerprint. According to some embodiments, the correction data may include high correction data obtained by correcting the high fingerprint data, and low correction data obtained by correcting the low fingerprint data. According to some embodiments, the high fingerprint data and the low fingerprint data may have random values for each of the respective locations of the plurality of sensor pixels, and each of the high correction data and the low correction data may have a constant value in all of the plurality of sensor pixels.

According to some embodiments, the method may further include detecting a user's fingerprint according to the correction data.

### BRIEF DESCRIPTION OF DRAWINGS

The above and other aspects, features, and characteristics of embodiments according to the present disclosure will be more apparent from the following description taken in conjunction with the accompanying drawings, in which:

FIG. 1 is a schematic plan view of a portion of a display apparatus according to some embodiments;

FIG. 2 is a schematic cross-sectional view of the display apparatus according to some embodiments;

FIG. 3 is an equivalent circuit diagram of a pixel circuit electrically connected to a light-emitting element of the display apparatus according to some embodiments and a sensor circuit electrically connected to a light-receiving element of the display apparatus;

FIG. 4 is a schematic block diagram of an inspection system and a sensor system according to some embodiments;

FIG. 5 is a flowchart of a fingerprint detection method using a display apparatus, according to some embodiments;

FIG. 6 is a flowchart of some operations included in the fingerprint detection method using a display apparatus, according to some embodiments; and

FIGS. 7 through 10 are graphs showing pieces of data in the fingerprint detection method using a display apparatus, according to some embodiments.

### DETAILED DESCRIPTION

Reference will now be made in more detail to aspects of some embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, particular embodiments will be illustrated in the drawings and described in more detail in the written description. Hereinafter, effects and features of the disclosure and a method for accomplishing them will be described more fully with reference to the accompanying drawings, in which embodiments of the disclosure are shown. The disclosure may, however, be embodied in many different forms and should not be construed as limited to the embodiments set forth herein.

One or more embodiments of the disclosure will be described below in more detail with reference to the accompanying drawings. Those components that are the same as or are in correspondence with each other are rendered the same reference numeral regardless of the figure number, and redundant explanations are omitted.

It will be understood that although the terms “first,” “second,” etc. may be used herein to describe various components, these components should not be limited by these terms. These components are only used to distinguish one component from another.

As used herein, the singular forms “a,” “an,” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of elements in the drawings may be exaggerated or reduced for convenience of explanation. For example, because sizes and thicknesses of components in the drawings are arbitrarily illustrated for convenience of explanation, embodiments are not limited thereto.

When a certain embodiment may be implemented differently, a specific process order may be performed differently from the described order. For example, two consecutively described processes may be performed substantially at the same time or performed in an order opposite to the described order.

It will also be understood that when a layer, region, or component is referred to as being “connected” or “coupled” to another layer, region, or component, it can be directly connected or coupled to the other layer, region, or component or intervening layers, regions, or components may be present. For example, when a layer, region, or component is referred to as being “electrically connected” or “electrically coupled” to another layer, region, or component, it can be directly electrically connected or coupled to the other layer, region, or component or intervening layers, regions, or components may be present.

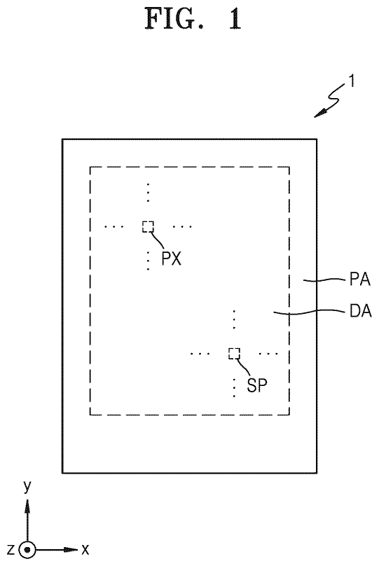

FIG. 1 is a schematic plan view of a portion of a display apparatus 1 according to some embodiments.

Referring to FIG. 1, the display apparatus 1 may include a display area DA in which a plurality of display pixels PX are arranged, and a peripheral area PA located outside (e.g., in a periphery or outside a footprint of) the display area DA. For example, the peripheral area PA may surround the entire display area DA. This may be understood as a substrate included in the display apparatus 1 having the display area DA and the peripheral area PA.

Each of the plurality of display pixels PX of the display apparatus 1 may represent a minimum unit for displaying images, and the display apparatus 1 may display a desired image through a combination of the plurality of display pixels PX. For example, each of the plurality of display pixels PX may emit light of a certain color, and the display apparatus 1 may display a desired image by using light emitted by the plurality of display pixels PX. For example, each of the plurality of display pixels PX may emit red light, green light, or blue light. Each of the plurality of display pixels PX may include a light-emitting element such as an organic light-emitting diode. The display pixel PX may be connected to a pixel circuit including a thin film transistor (TFT), a storage capacitor, etc.

The display area DA may include a sensing area in which a plurality of sensor pixels SP are arranged. The sensing area is not an area where only the plurality of sensor pixels SP are arranged, but may also include at least some display pixels PX among the plurality of display pixels PX included in the display area DA. According to some embodiments, a portion of the display area DA may be set as the sensing area. According to some embodiments, the entire display area DA may be set as the sensing area.

Each of the plurality of sensor pixels SP may include a light-receiving element, and may detect reflected light obtained by a user's finger reflecting light emitted from a light source. The display apparatus 1 may detect the user's fingerprint by analyzing the reflected light. The disclosure will now be described by taking as an example that each of the plurality of sensor pixels SP is used for fingerprint detection. However, according to various embodiments, the plurality of sensor pixels SP may perform various functions such as a touch sensor or a scanner.

Each of the plurality of sensor pixels SP may overlap at least some or all of the plurality of display pixels PX provided in the sensing area, or may be arranged around the display pixels PX. For example, at least some or all of the plurality of sensor pixels SP may be provided between display pixels PX.

The display area DA may have the shape of a polygon including a quadrangle, as shown in FIG. 1. For example, the display area DA may have a rectangular shape in which a horizontal length is greater than a vertical length, a rectangular shape in which a horizontal length is less than a vertical length, or a square shape. Alternatively, the display area DA may have any of various shapes such as an oval or a circle.

The peripheral area PA may be a non-display area in which no display pixels PX are located and images are not displayed. A driver or the like for providing an electrical signal or power to the display pixels PX may be arranged in the peripheral area PA. Pads where various electronic devices or printed circuit boards (PCBs) may be electrically connected to each other may be located in the peripheral area PA. The pads are arranged such that they are spaced apart from each other in the peripheral area PA, and may be electrically connected to a PCB or an integrated circuit device.

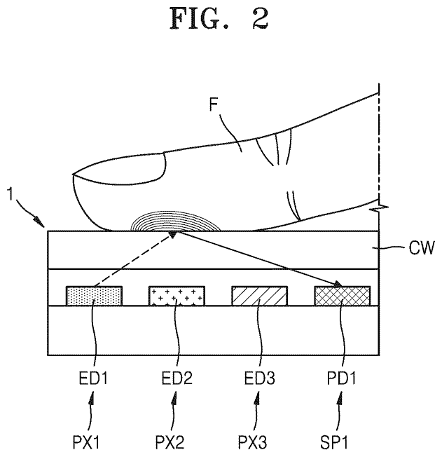

FIG. 2 is a schematic cross-sectional view of the display apparatus 1 according to some embodiments.

Referring to FIG. 2, the display apparatus 1 according to some embodiments may include a plurality of display pixels, namely, first, second, and third display pixels PX1, PX2, and PX3, and a first sensor pixel SP1. The first display pixel PX1 may include a first light-emitting element ED1, the second display pixel PX2 may include a second light-emitting element ED2, and the third display pixel PX3 may include a third light-emitting element ED3. The first sensor pixel SP1 may include a first light-receiving element PD1. The first light-emitting element ED1, the second light-emitting element ED2, and the third light-emitting element ED3 may emit different lights. For example, the first light-emitting element ED1 may emit green light, the second light-emitting element ED2 may emit red light, and the third light-emitting element ED3 may emit blue light.

As shown in FIG. 2, the display apparatus 1 may have a function of sensing an object in contact with the cover window CW, for example, a fingerprint of a finger F. At least a portion of reflected light reflected by the user's fingerprint from among the light emitted from at least one of the first light-emitting element ED1, the second light-emitting element ED2, or the third light-emitting element ED3 is re-incident upon the first light-receiving element PD1, so that the first light-receiving element PD1 may detect the reflected light. For example, the green light emitted by the first light-emitting element ED1 is reflected by the object in contact with the cover window CW and is re-incident upon the first light-receiving element PD1, so that the first light-receiving element PD1 may detect the re-incident green light.

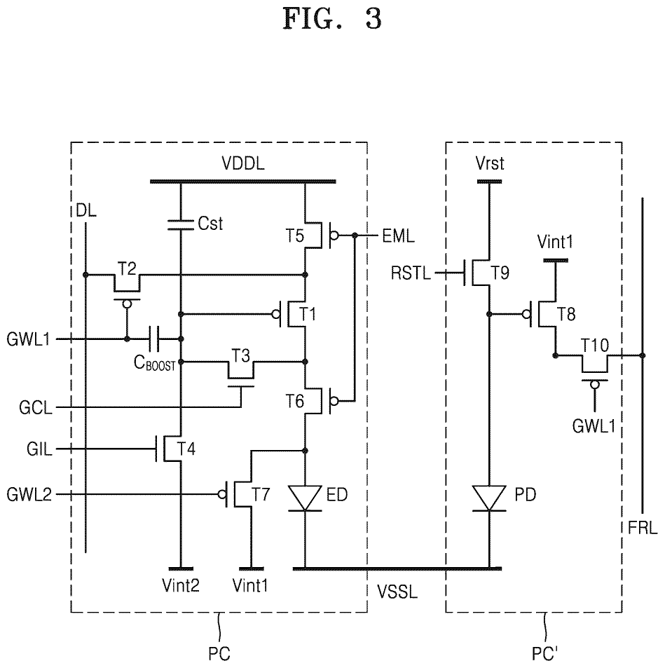

FIG. 3 is an equivalent circuit diagram of a pixel circuit electrically connected to a light-emitting element of a display apparatus according to some embodiments and a sensor circuit electrically connected to a light-receiving element of the display apparatus. Although FIG. 3 illustrates various components, embodiments according to the present disclosure are not limited thereto, and various embodiments may include additional components or fewer components without departing from the spirit and scope of embodiments according to the present disclosure.

Referring to FIG. 3, the display pixel PX of FIG. 1 may include a light-emitting element ED and a pixel circuit PC that controls the amount of light emitted by the light-emitting element ED, and the sensor pixel SP of FIG. 1 may include a light-receiving element PD and a sensor circuit PC′ that controls the amount of light received by the light-receiving element PD.

Each pixel circuit PC may be connected to a scan start line GIL, a scan control line GCL, a first scan write line GWL1, a second scan write line GWL2, an emission line EML, and a data line DL. Each pixel circuit PC may also be connected to a first driving voltage line VDDL to which a first driving voltage is applied, a second driving voltage line VSSL to which a second driving voltage is applied, a first initializing voltage line to which a first initializing voltage Vint1 is applied, and a second initializing voltage line to which a second initializing voltage Vint2 is applied.

Each sensor circuit PC′ may be connected to the first scan write line GWL1, a reset line RSTL, and a fingerprint detection line FRL. Each sensor circuit PC′ may also be connected to the second driving voltage line VSSL to which the second driving voltage is applied, a reset voltage line to which a reset voltage Vrst is applied, and the first initializing voltage line to which the first initializing voltage Vint1 is applied.

Each pixel circuit PC may include a plurality of transistors and at least one capacitor, and may be connected to the light-emitting element ED. The plurality of transistors may include first, second, third, fourth, fifth, sixth, and seventh transistors T1, T2, T3, T4, T5, T6, and T7. Among the plurality of transistors, the first transistor T1 may be a driving transistor, and the second through seventh transistors T2 through T7 may be transistors serving as switching elements that are turned on or off according to scan signals applied to respective gate electrodes of the second through seventh transistors T2 through T7.

The first transistor T1 may include a gate electrode, a first electrode, and a second electrode. The gate electrode of the first transistor T1 may be connected to a first electrode of the third transistor T3 and one electrode of the storage capacitor Cst, the first electrode of the first transistor T1 may be connected to a second electrode of the second transistor T2 and a second electrode of the fifth transistor T5, and the second electrode of the first transistor T1 may be connected to a second electrode of the third transistor T3 and a first electrode of the sixth transistor T6.

The light-emitting element ED emits light according to a driving current. The amount of light emitted by the light-emitting element ED may be proportional to the driving current. The light-emitting element ED may be an organic light-emitting diode including a pixel electrode, an opposite electrode, and an organic emission layer located between the pixel electrode and the opposite electrode.

Alternatively, the light-emitting element ED may be an inorganic light-emitting diode including an inorganic emission layer located between the pixel electrode and the opposite electrode, or may be a quantum dot light-emitting diode including a quantum dot emission layer located between the pixel electrode and the opposite electrode. Alternatively, the light-emitting element ED may be a micro light-emitting diode. The pixel electrode of the light-emitting element ED may be connected to a second electrode of the sixth transistor T6 and a second electrode of the seventh transistor T7, and the opposite electrode of the light-emitting element ED may be connected to the second driving voltage line VSSL.

The second transistor T2 may be turned on by a scan signal of the first scan write line GWL1 to thereby connect the first electrode of the first transistor T1 to the data line DL. The gate electrode of the second transistor T2 may be connected to the first scan write line GWL1, a first electrode of the second transistor T2 may be connected to the data line DL, and a second electrode of the second transistor T2 may be connected to the first electrode of the first transistor T1.

The third transistor T3 may be turned on by a scan signal of the scan control line GCL to thereby connect the gate electrode of the first transistor T1 to the second electrode of the first transistor T1. That is, when the third transistor T3 is turned on, the gate electrode and the second electrode of the first transistor T1 are connected to each other, so the first transistor T1 may be driven as a diode. The gate electrode of the third transistor T3 may be connected to the scan control line GCL, the first electrode of the third transistor T3 may be connected to the second electrode of the first transistor T1, and the second electrode of the third transistor T3 may be connected to the gate electrode of the first transistor T1.

The fourth transistor T4 may be turned on by a scan signal of the scan start line GIL to thereby connect the gate electrode of the first transistor T1 to the second initializing voltage line. In this case, the gate electrode of the first transistor T1 may be discharged to the second initialization voltage Vint2 of the second initialization voltage line. The gate electrode of the fourth transistor T4 may be connected to the scan control line GCL, a first electrode of the fourth transistor T4 may be connected to the second electrode of the first transistor T1, and a second electrode of the fourth transistor T4 may be connected to the gate electrode of the first transistor T1.

The fifth transistor T5 may be turned on by an emission signal of the emission line EML to thereby connect the first electrode of the first transistor T1 to the first driving voltage line VDDL. The gate electrode of the fifth transistor T5 may be connected to the emission line EML, a first electrode of the fifth transistor T5 may be connected to the first driving voltage line VDDL, and a second electrode of the fifth transistor T5 may be connected to the first electrode of the first transistor T1.

The sixth transistor T6 may be turned on by an emission signal of the emission line EML to thereby connect the second electrode of the first transistor T1 to the pixel electrode of the light-emitting element ED. The gate electrode of the sixth transistor T6 may be connected to the emission line EML, the first electrode of the sixth transistor T6 may be connected to the second electrode of the first transistor T1, and the second electrode of the sixth transistor T6 may be connected to the pixel electrode of the light-emitting element ED. When both the fifth transistor T5 and the sixth transistor T6 are turned on, the driving current may be supplied to the light-emitting element ED.

The seventh transistor T7 may be turned on by a scan signal of the second scan write line GWL2 to thereby connect the first initializing voltage line to the pixel electrode of the light-emitting element ED. In this case, the pixel electrode of the light-emitting element ED may be discharged to the first initializing voltage Vint1. The gate electrode of the seventh transistor T7 may be connected to the second scan write line GWL2, the first electrode of the seventh transistor T7 may be connected to the first initializing voltage line, and the second electrode of the seventh transistor T7 may be connected to the pixel electrode of the light-emitting element ED.

The storage capacitor Cst may be formed between the gate electrode of the first transistor T1 and the first driving voltage line VDDL. One electrode of the storage capacitor Cst may be connected to the gate electrode of the first transistor T1, and the other end thereof may be connected to the first driving voltage line VDDL. Accordingly, the storage capacitor Cst may maintain a potential difference between the gate electrode of the first transistor T1 and the first driving voltage line VDDL.

A boost capacitor C_{BOOST} may be formed between the gate electrode of the second transistor T2 and the gate electrode of the first transistor T1. One electrode of the boost capacitor C_{BOOST} may be connected to the first scan write line GWL1 connected to the gate electrode of the second transistor T2, and the other electrode thereof may be connected to the gate electrode of the first transistor T1 and the one electrode of the storage capacitor Cst. The boost capacitor C_{BOOST} is a boosting capacitor, and, when a signal of the first scan write line GWL1 is a voltage that turns off the second transistor T2, the boost capacitor C_{BOOST} may increase the voltage of a node to thereby reduce a voltage (black voltage) that expresses a black color.

Each sensor circuit PC′ may include a plurality of transistors and may be connected to the light-receiving element PD. The plurality of transistors may include eighth, ninth, and tenth transistors T8, T9, and T10. Among the plurality of transistors, the eighth transistor T8 may be a driving transistor, and the ninth and tenth transistors T9 and T10 may be transistors serving as switching elements that are turned on or off according to a reset signal and a scan signal respectively applied to respective gate electrodes of the ninth and tenth transistors T9 and T10.

When a plurality of light-emitting elements ED and a plurality of light-receiving elements PD are arranged in one display apparatus 1 of FIG. 1, voltage wiring or signal wiring for driving the light-emitting element ED may be shared when driving the light-receiving element PD. That is, by minimizing or reducing additional arrangement of voltage wires or signal wires for driving the plurality of light-receiving elements PD in the display apparatus 1 of FIG. 1, the resolution of the display apparatus 1 of FIG. 1 may be secured, and the peripheral area PA of FIG. 1 may be minimized. For example, a signal wire connected to the gate electrode of the second transistor T2 of the display pixel PX of FIG. 1 may be shared with a signal wire connected to the gate electrode of the tenth transistor T10 of an optical sensor. That is, the gate electrode of the second transistor T2 and the gate electrode of the tenth transistor T10 may be connected to the first scan write line GWL1. For another example, the second driving voltage line VSSL may be a common voltage wire connected to the opposite electrode of the light-emitting element ED and the opposite electrode of the light-receiving element PD. For another example, the first initializing voltage line that applies the first initializing voltage Vint1 may be a common voltage wire that is connected to the second electrode of the eighth transistor T8 and the second electrode of the seventh transistor T7 of the optical sensor.

Each of the light-receiving elements PD may be a light-receiving diode including a sensing electrode, an opposite electrode, and a photoelectric conversion layer located between the sensing electrode and the opposite electrode. Each of the light-receiving elements PD may convert light incident from the outside into an electrical signal. The light-receiving element PD may be a light-receiving diode formed of a pn-type or pin-type inorganic material, or a photo transistor. Alternatively, the light-receiving element PD may be an organic light-receiving diode including an electron donating material for generating donor ions and an electron accepting material for generating acceptor ions.

When the light-receiving element PD is exposed to external light, the light-receiving element PD may generate photocharges, and the generated photocharges may be accumulated in the sensing electrode of the light-receiving element PD. In this case, the voltage of a node electrically connected to the sensing electrode may increase. When the light-receiving element PD and the fingerprint detection line FRL are connected to each other according to turn-on operations of the eighth transistor T8 and the tenth transistor T10, a current may flow in the fingerprint detection line FRL in proportion to the voltage of a node in which charges are accumulated.

The eighth transistor T8 may be turned on by the voltage applied to the gate electrode to connect the first electrode of the tenth transistor T10 to the first initializing voltage line. In this case, the second electrode of the tenth transistor T10 may be discharged to the first initializing voltage Vint1. The gate electrode of the eighth transistor T8 may be connected to a node between the ninth transistor T9 and the light-receiving element PD, a first electrode of the eighth transistor T8 may be connected to the first initializing voltage line, and a second electrode of the eighth transistor T8 may be connected to the first electrode of the tenth transistor T10. The eighth transistor T8 may be a source follower amplifier that generates a source-drain current in proportion to the amount of charge of the node that is input to the gate electrode. The first electrode of the eighth transistor T8 may be connected to the first driving voltage line VDDL or the second initializing voltage line.

The tenth transistor T10 may be turned on by the scan signal of the first scan write line GWL1 to thereby connect the second electrode of the eighth transistor T8 to the fingerprint detection line FRL. The fingerprint detection line FRL may transmit a fingerprint detection signal to a read-out circuit. The gate electrode of the tenth transistor T10 may be connected to the first scan write line GWL1, a first electrode of the tenth transistor T10 may be connected to the second electrode of the eighth transistor T8, and a second electrode of the tenth transistor T10 may be connected to the fingerprint detection line FRL.

The ninth transistor T9 may be turned on by a reset signal of the reset line RSTL to thereby reset a node connected to the gate electrode of the eighth transistor T8 with the reset voltage Vrst. The gate electrode of the ninth transistor T9 may be connected to the reset line RSTL, a first electrode of the ninth transistor T9 may be connected to the reset voltage line, and a second electrode of the ninth transistor T9 may be connected to a node that connects the light-receiving element PD to the eighth transistor T8. When a reset driver that outputs the reset signal of the reset line RSTL is omitted, the ninth transistor T9 may be turned on by the scan signal.

When the first electrode of each of the first, second, third, fourth, fifth, sixth, seventh, eighth, ninth, and tenth transistors T1, T2, T3, T4, T5, T6, T7, T8, T9, and T10 is a source electrode, the second electrode thereof may be a drain electrode. Alternatively, when the first electrode of each of the first, second, third, fourth, fifth, sixth, seventh, eighth, ninth, and tenth transistors T1, T2, T3, T4, T5, T6, T7, T8, T9, and T10 is a drain electrode, the second electrode thereof may be a source electrode.

An active layer of each of the first, second, third, fourth, fifth, sixth, seventh, eighth, ninth, and tenth transistors T1, T2, T3, T4, T5, T6, T7, T8, T9, and T10 may be formed of one of polycrystalline silicon, amorphous silicon, and oxide semiconductor. For example, the first and second transistors T1 and T2, the fifth through eighth transistors T5, T6, T7, and T8, and the tenth transistor T10 may be P-type transistors. In this case, respective active layers of the first and second transistors T1 and T2, the fifth through eighth transistors T5, T6, T7, and T8, and the tenth transistor T10 may be formed of polysilicon. Each of the third transistor T3, the fourth transistor T4, and the ninth transistor T9 may be an N-type transistor that forms an active layer of an oxide semiconductor.

However, embodiments according to the present disclosure are not limited thereto, and each of the first, second, third, fourth, fifth, sixth, seventh, eighth, ninth, and tenth transistors T1, T2, T3, T4, T5, T6, T7, T8, T9, and T10 may be a P-type transistor. For another example, the eighth, ninth, and tenth transistors T8, T9, and T10 may be formed as P-type transistors.

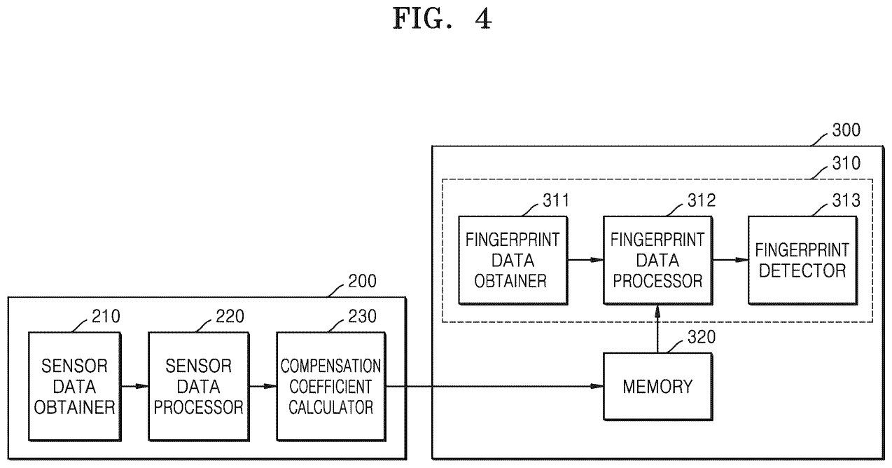

FIG. 4 is a schematic block diagram of an inspection system and a sensor system according to some embodiments.

Referring to FIG. 4, a fingerprint detection method performed by the display apparatus 1 according to some embodiments may include an inspection system 200 and a sensor system 300. The inspection system 200 may be built into an inspection device for inspecting the display apparatus 1 of FIG. 1, and the sensor system 300 may be built into the display apparatus 1 of FIG. 1.

The inspection system 200 and the sensor system 300 may correct data so that the plurality of sensor pixels SP of FIG. 1 may operate properly. For example, as described above with reference to FIG. 3, the sensor circuit PC′ may include an eighth transistor T8, a ninth transistor T9, and a tenth transistor T10, of which the eighth transistor T8 may be a driving transistor. The driving transistor may be more affected by process characteristics than a switching transistor, which simply functions as a switch on-off role, and thus dispersion may be large for each sensor pixel SP of FIG. 1. In other words, pieces of fingerprint data respectively included in the plurality of sensor pixels SP of FIG. 1 included in the display apparatus 1 of FIG. 1 may have random values due to the distribution of the driving transistor, and deviations may occur. In this case, a display apparatus and a fingerprint detection method using the same, according to some embodiments, may relatively improve sensing sensitivity by removing deviations of the pieces of the fingerprint data by using the inspection system 200 and the sensor system 300.

The inspection system 200 may check whether the plurality of sensor pixels SP of FIG. 1 included in the display apparatus 1 of FIG. 1 operate normally, and may check sensor data of each of the plurality of sensor pixels SP of FIG. 1. For example, the inspection system 200 may include a sensor data obtainer 210, a sensor data processor 220, and a compensation coefficient calculator 230.

The sensor data obtainer 210 may secure pieces of raw data by measuring a current value of the light-receiving element included in each of the plurality of sensor pixels SP of FIG. 1. For example, the sensor data obtainer 210 may secure various pieces of raw data in several inspection environments.

The sensor data processor 220 may process the pieces of raw data obtained by the sensor data obtainer 210 to calculate sensor data. For example, the sensor data processor 220 may play a filtering role of removing pieces of error data that are outside an allowable range from among the pieces of raw data.

The compensation coefficient calculator 230 may receive the pieces of processed sensor data and calculate a compensation coefficient capable of compensating for the data of each of the plurality of sensor pixels SP of FIG. 1. The compensation coefficient for each sensor pixel SP calculated by the compensation coefficient calculator 230 may be stored in the memory 320, which will be described later.

The sensor system 300 may drive the plurality of sensor pixels SP of FIG. 1 included in the display apparatus 1 of FIG. 1. However, the sensor system 300 may include a process of correcting data so that the plurality of sensor pixels SP of FIG. 1 may be driven more accurately. For example, the sensor system 300 may include a sensor controller 310 and a memory 320, and the sensor controller 310 may include a fingerprint data obtainer 311, a fingerprint data processor 312, and a fingerprint detector 313.

The fingerprint data obtainer 311 may generate pieces of fingerprint data by measuring reflected light of the user's fingerprint in the plurality of sensor pixels SP of FIG. 1 of the display apparatus 1 of FIG. 1. The fingerprint data may be data obtained by converting light reflected by the user's finger and incident upon the light-receiving element of each sensor pixel SP of FIG. 1 into an electrical signal. The pieces of fingerprint data may have a random value for each of the plurality of sensor pixels SP of FIG. 1.

The memory 320 may store the compensation coefficients calculated by the inspection system 200. However, the memory 320 may store not only the compensation coefficient of each of the plurality of sensor pixels SP of FIG. 1 but also the sensor data of each of the plurality of sensor pixels SP of FIG. 1.

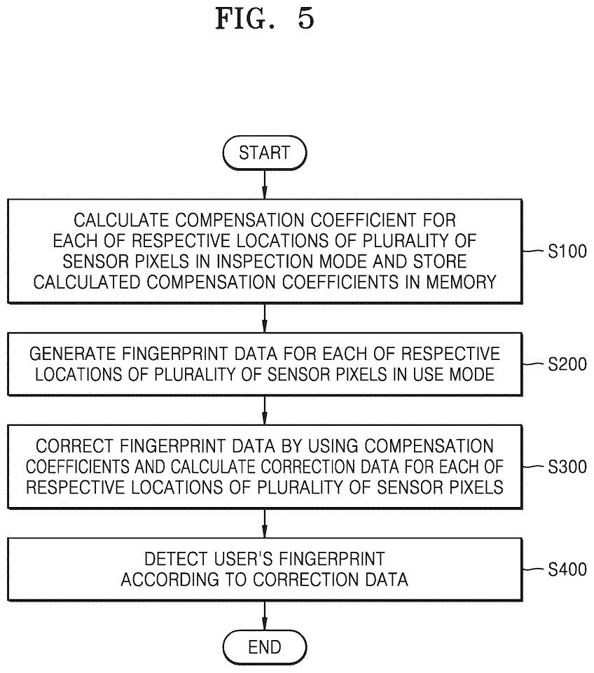

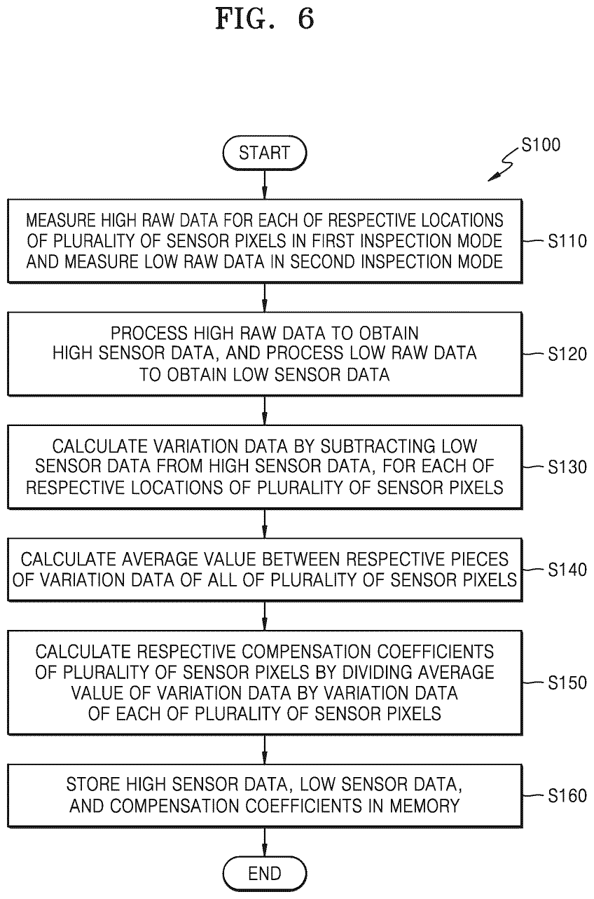

The fingerprint data processor 312 may correct the pieces of fingerprint data obtained by the fingerprint data obtainer 311 to calculate correction data. The fingerprint data processor 312 may calculate the correction data by using the compensation coefficients and the sensor data both stored in the memory 320. A process of correcting fingerprint data will be described in more detail later with reference to FIGS. 5 and 6.

The fingerprint detector 313 may detect the user's fingerprint by using the correction data detected by the fingerprint data processor 312. Because the correction data is a value obtained by correcting the fingerprint data to remove deviations, the correction data may be judged more accurately than the fingerprint data. Accordingly, a display apparatus and a fingerprint detection method using the same, according to some embodiments, may relatively improve sensing sensitivity.

FIG. 5 is a flowchart of a fingerprint detection method using a display apparatus, according to some embodiments. FIG. 6 is a flowchart of some operations included in the fingerprint detection method using a display apparatus, according to some embodiments. Although FIGS. 5 and 6 illustrate various operations, embodiments according to the present disclosure are not limited thereto, and according to various embodiments, there may be additional operations or fewer operations, or the order of operations may vary, without departing from the spirit and scope of embodiments according to the present disclosure, unless otherwise explicitly explained or implied.

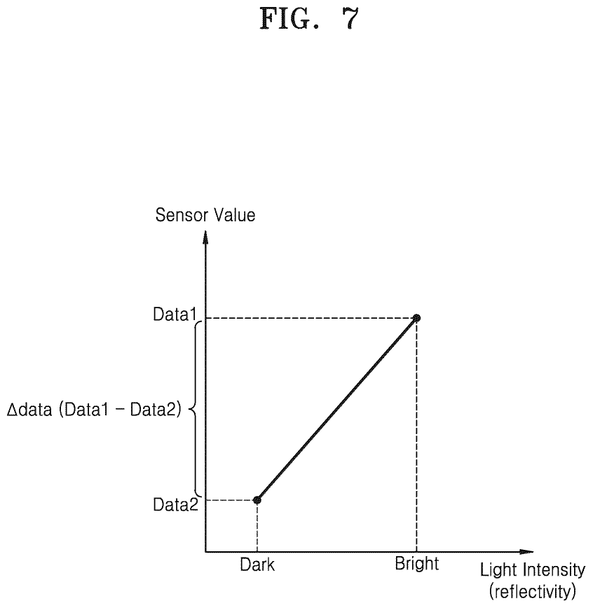

FIGS. 7 through 10 are graphs showing pieces of data in the fingerprint detection method using a display apparatus, according to some embodiments.

Referring to FIG. 5, the fingerprint detection method using a display apparatus according to some embodiments may include operation S100 of calculating a compensation coefficient for each of respective locations of a plurality of sensor pixels in an inspection mode and storing the calculated compensation coefficients in a memory, operation S200 of generating fingerprint data for each of the respective locations of the plurality of sensor pixels in a use mode, operation S300 of correcting the fingerprint data by using the compensation coefficients and calculating correction data for each of the respective locations of the plurality of sensor pixels, and operation S400 of detecting the user's fingerprint according to the correction data.

First, in the inspection mode, a compensation coefficient may be calculated for each of respective locations of the plurality of sensor pixels SP of FIG. 1 and stored in the memory 320 of FIG. 4. That is, sensor data of each of the plurality of sensor pixels SP of FIG. 1 may be secured by inspecting the display apparatus 1 of FIG. 1 by using an inspection device.

For example, referring to FIG. 6, operation S100 of calculating the compensation coefficients and storing them in the memory may include operation S110 of measuring high raw data for each of the respective locations of the plurality of sensor pixels in a first inspection mode and measuring low raw data in a second inspection mode, operation S120 of processing the high raw data to obtain high sensor data and processing the low raw data to obtain low sensor data, operation S130 of calculating variation data by subtracting the low sensor data from the high sensor data, for each of the respective locations of the plurality of sensor pixels, operation S140 of calculating an average value of variation data of all of the plurality of sensor pixels, operation S150 of calculating the respective compensation coefficients of the plurality of sensor pixels by dividing the average value of the variation data by the variation data of each of the plurality of sensor pixels, and operation S160 of storing the high sensor data, the low sensor data, and the compensation coefficients in the memory.

First, the inspection system 200 of FIG. 4 may measure raw data for each of the respective locations of the plurality of sensor pixels SP of FIG. 1 by using the sensor data obtainer 210 of FIG. 4 (S110). The plurality of sensor pixels SP of FIG. 1 may include first through n-th sensor pixels sequentially arranged from an upper left end to a lower right end in a plan view. Accordingly, the inspection device may measure respective pieces of raw data of the first through n-th sensor pixels. That is, the respective pieces of raw data may include first through n-th raw data divided according to locations where the plurality of sensor pixels SP of FIG. 1 are arranged.

However, the inspection device may not measure pieces of raw data in one environment, but may measure pieces of raw data in multiple environments. According to some embodiments, the inspection device may measure the high raw data in the first inspection mode and may measure the low raw data in the second inspection mode. In this case, in the first inspection mode, an inspection may be performed in a bright environment, and, in the second inspection mode, an inspection may be performed in a dark environment.

For example, in the first inspection mode, the inspection may be performed with a reflector placed on the display apparatus 1 of FIG. 1 located on the inspection device and green light being turned on. That is, the first inspection mode may be creation of a bright environment so that data similar to light reflected by the valleys of the user's fingerprint is produced. To this end, the reflector may have a reflectivity in a ±30% range of the amount of light reflected by the valleys of the fingerprint. This is because, when the reflectivity of the reflector is outside the ±30% range and thus it is too bright or too dark, sensing sensitivity may be reduced. For example, the reflector may have a reflectivity similar to a skin color. The reflector may have a flat shape or may have a convex shape such as an integrating sphere shape. However, the reflector may be positioned at a distance of 1 mm or more to prevent scratches or foreign matters that may occur on the display apparatus 1 of FIG. 1.

In the second inspection mode, the inspection may be performed with a light-absorbing plate placed on the display apparatus 1 of FIG. 1 located on the inspection device and external light being blocked. In this case, the inspection may be performed with a display apparatus 1 of FIG. 1 being covered with a black box other than the light-absorbing plate. That is, the second inspection mode may be creation of a dark environment so that data similar to light reflected by the ridges of the user's fingerprint is produced. Similar to the reflector, the light-absorbing plate may be positioned at a distance of 1 mm or more to prevent scratches or foreign matters that may occur on the display apparatus 1 of FIG. 1.

The pieces of high raw data measured in the first inspection mode and the pieces of low raw data measured in the second inspection mode may each include values obtained via multiple photographing operations at the location of the same sensor pixel SP of FIG. 1. For example, the pieces of high raw data measured in the first inspection mode may include first high raw data measured at a first sensor pixel, second high raw data measured at a second sensor pixel, and n-th high raw data measured at an n-th sensor pixel. In this case, the first high raw data through to the n-th high raw data may have multiple sensor current values respectively measured at sensor pixels SP of FIG. 1. That is, each of the first high raw data through to the n-th high raw data is data for one sensor pixel SP of FIG. 1, but may have several values rather than one value.

Next, the inspection system 200 of FIG. 4 may process pieces of high raw data and pieces of low raw data by using the sensor data processor 220 of FIG. 4 (S120). The sensor data processor 220 of FIG. 4 may create high sensor data by processing the pieces of high raw data, and may create low sensor data by processing the pieces of low raw data.

The high sensor data is a valid value obtained by filtering several values of the pieces of high raw data, and the low raw data is a valid value obtained by filtering several values of the pieces of high raw data. For example, the high sensor data is an average value of pieces of valid data excluding pieces of mis-measurement data that are outside the allowable range among the pieces of high raw data obtained through multiple photographing operations in the first inspection mode. The low sensor data is an average value of pieces of valid data excluding pieces of mis-measurement data that are outside the allowable range among the pieces of low raw data obtained through multiple photographing operations in the second inspection mode. In other words, the high sensor data may be considered a representative sensor current value measured in the first inspection mode, and the low sensor data may be considered as a representative sensor current value measured in the second inspection mode.

Generating sensor data by processing raw data as described above is to reduce errors and increase the accuracy of sensor data, because the errors may occur due to a specific event even during an inspection process.

Additionally, the high sensor data may also have first through n-th high sensor data corresponding to the first through n-th sensor pixels. The low sensor data may also have first through n-th low sensor data corresponding to the first through n-th sensor pixels. For example, in the first sensor pixel, the first high sensor data may be secured in the first inspection mode, and the first low sensor data may be secured in the second inspection mode. Likewise, in the n-th sensor pixel, the n-th high sensor data may be secured in the first inspection mode, and the n-th low sensor data may be secured in the second inspection mode.

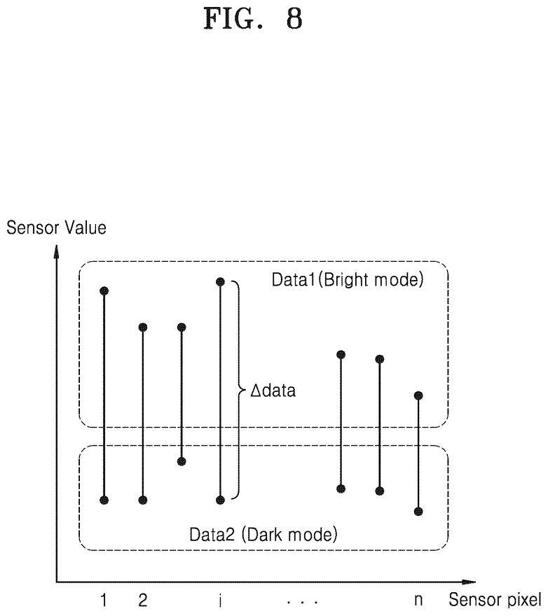

This will now be described in more detail with reference to FIGS. 7 and 8. FIGS. 7 and 8 are graphs showing pieces of sensor data in the fingerprint detection method using a display apparatus, according to some embodiments. First, the horizontal axis of the graph of FIG. 7 indicates light intensity, that is, reflectivity, in an inspection environment, and the vertical axis thereof indicates a sensor current value of a sensor pixel SP of FIG. 1. In this case, the graph in FIG. 7 shows sensor data in two inspection environments. For example, FIG. 7 shows high sensor data Data1 measured in a bright environment, which is the first inspection mode, and low sensor data Data2 measured in a dark environment, which is the second inspection mode. In this case, the high sensor data Data1 and the low sensor data Data2 may be data obtained by processing pieces of raw data as described above.

The horizontal axis of the graph of FIG. 8 indicates a plurality of sensor pixels, and the vertical axis thereof indicates a sensor current value of a sensor pixel SP of FIG. 1. For example, FIG. 8 shows high sensor data Data1 and low sensor data Data2 of each of the first through n-th sensor pixels. That is, the inspection system 200 of FIG. 4 may secure first high sensor data in a bright environment from the first sensor pixel, and may secure first low sensor data in a dark environment from the first sensor pixel. Likewise, the inspection system 200 of FIG. 4 may secure second high sensor data and second low sensor data from the second sensor pixel, and may secure n-th high sensor data and n-th low sensor data from the n-th sensor pixel.

As shown in FIG. 8, respective pieces of sensor data of the first through n-th sensor pixels may have random values. That is, the first through n-th high sensor data may have deviations for each sensor pixel, and the first through n-th low sensor data may also have deviations for each sensor pixel. This may be due to the distribution of the driving transistor of the sensor circuit PC′ of FIG. 3, as described above.

Referring back to FIG. 6, next, the compensation coefficient calculator 230 (see FIG. 4) of the inspection system 200 (see FIG. 4) may calculate variation data Δdata by subtracting the low sensor data from the high sensor data for each of the respective locations of the plurality of sensor pixels SP of FIG. 1 (S130). In other words, the compensation coefficient calculator 230 (see FIG. 4) may calculate first through n-th variation data corresponding to the first through n-th sensor pixels. For example, in operation S130, the compensation coefficient calculator 230 (see FIG. 4) may secure the first variation data obtained by subtracting the first low sensor data from the first high sensor data in relation to the first sensor pixel. Likewise, the compensation coefficient calculator 230 (see FIG. 4) may secure the second variation data obtained by subtracting the second low sensor data from the second high sensor data in relation to the second sensor pixel, and may secure the n-th variation data obtained by subtracting the n-th low sensor data from the n-th high sensor data in relation to the n-th sensor pixel.

FIG. 8 shows the first through n-th high sensor data and the first through n-th low sensor data of the first through n-th sensor pixels. Referring to FIG. 8, the compensation coefficient calculator 230 (see FIG. 4) of the inspection system 200 (see FIG. 4) may calculate variation data Δdata by subtracting each low sensor data Data2 from each high sensor data Data1.

Next, the compensation coefficient calculator 230 (see FIG. 4) of the inspection system 200 (see FIG. 4) may calculate an average value Δavg of respective pieces of variation data Δdata of all of the plurality of sensor pixels SP of FIG. 1 (S140). In other words, the compensation coefficient calculator 230 (see FIG. 4) may calculate an average value Δavg of first through n-th variation data respectively corresponding to the first through n-th sensor pixels.

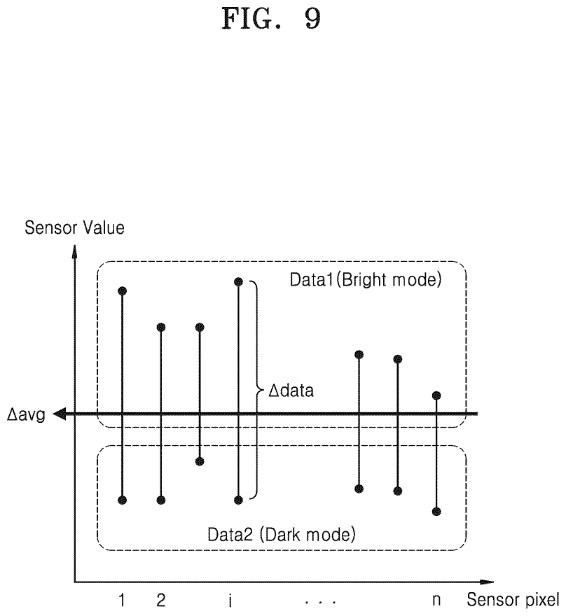

This will now be described in more detail with reference to FIG. 9. FIG. 9 is a graph showing sensor data in the fingerprint detection method using a display apparatus, according to some embodiments, and is almost the same as FIG. 8 but shows the average value Δavg. As shown in FIG. 9, the compensation coefficient calculator 230 of FIG. 4 may calculate respective pieces of variation data for the plurality of sensor pixels SP of FIG. 1 and then calculate an average value Δavg of the pieces of variation data.

Next, the compensation coefficient calculator 230 (see FIG. 4) of the inspection system 200 (see FIG. 4) may calculate the respective compensation coefficients of the plurality of sensor pixels SP of FIG. 1 by dividing the average value Δavg of the pieces of variation data by the respective pieces of variation data Δdata of the plurality of sensor pixels SP of FIG. 1 (S150). For example, the compensation coefficient calculator 230 of FIG. 4 may calculate a first compensation coefficient of the first sensor pixel by dividing the average value Δavg of the variation data by the first variation data. Likewise, the compensation coefficient calculator 230 of FIG. 4 may calculate a second compensation coefficient of the second sensor pixel by dividing the average value Δavg of the variation data by the second variation data, and may calculate an n-th compensation coefficient of the n-th sensor pixel by dividing the average value Δavg of the variation data by the n-th variation data.

In other words, each compensation coefficient may be calculated according to Equation 1 below.

$$σ n = Δ avg / Δ n \qquad Equation 1$$

where an may indicate the n-th compensation coefficient of the n-th sensor pixel, Δavg may indicate an average value of respective pieces of variation data of all of the sensor pixels SP of FIG. 1, and Δn may indicate the n-th variation data of the n-th sensor pixel. As described above, because pieces of sensor data have a random value for each of the plurality of sensor pixels SP of FIG. 1, compensation coefficients calculated by variation data of the pieces of sensor data may also have different values for each of the plurality of sensor pixels SP of FIG. 1.

Next, the inspection system 200 may store the respective compensation coefficients of the plurality of sensor pixels SP of FIG. 1 obtained by the compensation coefficient calculator 230 of FIG. 4 in the memory 320 of FIG. 4 (S160). In addition, the inspection system 200 may also store the high sensor data and the low sensor data both obtained by the sensor data processor 220 of FIG. 4 in the memory 320 of FIG. 4. The compensation coefficients, the high sensor data, and the low sensor data stored in the memory 320 of FIG. 4 may be used in a subsequent user's fingerprint data correction process.

Referring back to FIG. 5, next, the fingerprint data obtainer 311 (see FIG. 4) of the inspection system 200 of FIG. 4 may generate fingerprint data for each of the respective locations of the plurality of sensor pixels SP of FIG. 1 in a use mode (S200). Each of the plurality of sensor pixels SP of FIG. 1 may generate fingerprint data by detecting light reflected by the user's fingerprint through the light-receiving element.

Because the fingerprint data is obtained by detecting the user's fingerprint and converting a result of the detection into an electrical signal, the fingerprint data may include high fingerprint data, which is data about the valleys of the user's fingerprint, and low fingerprint data, which is data about the ridges of the user's fingerprint. The high fingerprint data may have a maximum value among pieces of fingerprint data corresponding to one sensor pixel SP of FIG. 1, and the low fingerprint data may have a minimum value among the pieces of fingerprint data corresponding to the one sensor pixel SP of FIG. 1.

Similar to the sensor data obtained by the inspection system 200 of FIG. 4, as for the fingerprint data, separate data may be obtained for the plurality of sensor pixels SP of FIG. 1, respectively. For example, first high fingerprint data and first low fingerprint data may be obtained from the first sensor pixel, second high fingerprint data and second low fingerprint data may be obtained from the second sensor pixel, and n-th high fingerprint data and n-th low fingerprint data may be obtained from the n-th sensor pixel. As described above, due to the distribution of the driving transistor of the sensor circuit PC′ of FIG. 3, the first through n-th high fingerprint data and the first through n-th low fingerprint data may have random values for each sensor pixel SP of FIG. 1.

Next, the fingerprint data processor 312 of the sensor system 300 may correct the pieces of fingerprint data obtained by the fingerprint data obtainer (or fingerprint data obtaining circuit or fingerprint data obtaining component) 311 to calculate correction data (S300). For example, the fingerprint data processor 312 may generate a compensation characteristic function by using the compensation coefficients calculated by the inspection system 200. The compensation coefficients required for the compensation characteristic function may be extracted from the memory 320.

The fingerprint data processor 312 may calculate the correction data, based on the pieces of fingerprint data. The correction data may include the first through n-th high correction data corresponding to the first through n-th high fingerprint data, and the first through n-th low correction data corresponding to the first through n-th low fingerprint data. For example, the first high correction data may be generated based on the first high fingerprint data, and the first low correction data may be generated based on the first low fingerprint data. The second high correction data may be generated based on the second high fingerprint data, and the second low correction data may be generated based on the second low fingerprint data. The n-th high correction data may be generated based on the n-th high fingerprint data, and the n-th low correction data may be generated based on the n-th low fingerprint data. That is, the first through n-th high correction data may correspond to the valleys of the user's fingerprint, and the first through n-th low correction data may correspond to the ridges of the user's fingerprint.

In this case, the compensation characteristic function may be the same as shown in Equation 2 below.

$$C ( n ) = [ R ( n ) - L ( n ) ] \times σ n \qquad Equation 2$$

where C(n) may indicate correction data of the n-th sensor pixel, R(n) may indicate fingerprint data of the n-th sensor pixel, L(n) may indicate raw sensor data of the n-th sensor pixel, and on may indicate a compensation coefficient of the n-th sensor pixel. As described above, because ‘σn=Δavg/Δn’, that is, ‘σi=Δavg/[H(n)−L(n)]’, Equation 2 may be expresses as ‘C(n)=[R(n)−L (n)]×Δavg/[H(n)−L(n)]’, where H(n) may indicate high sensor data of the n-th sensor pixel.

When the fingerprint data is corrected using the compensation characteristic function such as Equation 2, the correction data may have a specific value range. For example, when the n-th high fingerprint data has the same value as the value of the n-th high sensor data, that is, ‘R(n)=H(n)’, C(n), which is the high correction data of the corrected n-th sensor pixel, may have a value of Δavg. Alternatively, when the n-th low fingerprint data is the same as the n-th low sensor data, that is, ‘R(n)=L(n)’, C(n), which is the high correction data of the corrected n-th sensor pixel, may have a value of 0. That is, because the high correction data, which is a maximum value among the correction data, has a value of Δavg and the low correction data, which is a minimum value among the correction data, has a value of 0, the values of the correction data may be between 0 and Δavg.

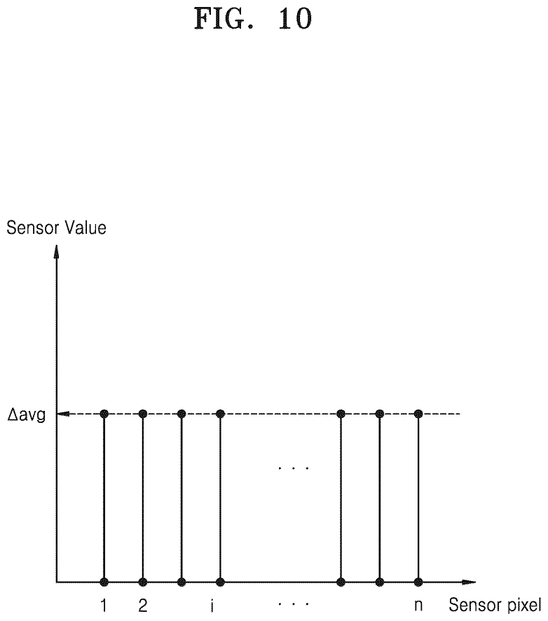

This will now be described in more detail with reference to FIG. 10. FIG. 10 is a graph showing correction data in the fingerprint detection method using a display apparatus, according to some embodiments. The horizontal axis of the graph of FIG. 10 indicates a plurality of sensor pixels, and the vertical axis thereof indicates a sensor current value of a sensor pixel SP of FIG. 1. For example, FIG. 10 shows high correction data and low correction data of each of the first through n-th sensor pixels. Referring to FIG. 10, it can be seen that all of first through n-th high correction data have a value of Δavg, and all of first through n-th low correction data have a value of 0.

That is, while the pieces of fingerprint data have random values due to a correction as described above, the pieces of correction data may have values within the range of 0 to Δavg. For example, all of the first through n-th high correction data may equally have a value of Δavg, and all of the first through n-th low correction data may have a value of 0. That is, because the first through n-th high correction data corresponding to the valleys of the fingerprint have a specific value and the first through n-th low correction data corresponding to the ridges of the fingerprint have a value of 0, the pieces of correction data may be judged more accurately than the pieces of fingerprint data with random values.

Next, the fingerprint detector 313 (see FIG. 4) of the sensor system 300 (see FIG. 4) may detect the user's fingerprint according to the correction data. For example, the fingerprint detector 313 (see FIG. 4) may detect the valleys of the user's fingerprint, based on the first through n-th high correction data, and may detect the ridges of the user's fingerprint, based on the first through n-th low correction data.

In this case, because both the first through n-th high correction data and the first through n-th low correction data have values from which deviations have been removed, the correction data may be more accurate than the fingerprint data in determining the valleys and ridges of the fingerprint. As a result, a display apparatus and a fingerprint detection method using the same, according to some embodiments, may compensate for fingerprint data by using correction data for each sensor pixel SP of FIG. 1, thereby relatively improving a sensor-to-noise ratio (S/N ratio) and sensing sensitivity.

As described above, a display apparatus and a fingerprint detection method using the same, according to some embodiments, may relatively improve an S/N ratio and sensing sensitivity as well as a display quality. These effects are only examples, and the scope of the disclosure is not limited thereto.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of embodiments according to the present invention.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims, and their equivalents.

What is claimed is:

1. A display apparatus comprising:
a display panel including a plurality of display pixels in which light-emitting elements are arranged, and a plurality of sensor pixels in which light-receiving elements are arranged;
a memory configured to store a compensation coefficient for each of respective locations of the plurality of sensor pixels; and
a sensor controller configured to correct a plurality of fingerprint data obtained from the plurality of sensor pixels, by using the compensation coefficient stored for each of the respective locations, to calculate a plurality of correction data.

2. The display apparatus of claim 1, wherein the plurality of fingerprint data are current values measured by the light-receiving elements respectively arranged in the plurality of sensor pixels that have detected light reflected by a user's fingerprint.

3. The display apparatus of claim 2, wherein
the plurality of fingerprint data include, for each of the respective locations of the plurality of sensor pixels,
high fingerprint data having a maximum value among pieces of data of the sensor pixels; and
low fingerprint data having a minimum value among the pieces of the data of the sensor pixels, and
the high fingerprint data and the low fingerprint data have random values for each of the plurality of sensor pixels.

4. The display apparatus of claim 3, wherein
the high fingerprint data is data about a valley of the user's fingerprint, and
the low fingerprint data is data about a ridge of the user's fingerprint.

5. The display apparatus of claim 3, wherein
each of the plurality of correction data comprises:
high correction data obtained by correcting the high fingerprint data; and
low correction data obtained by correcting the low fingerprint data,
the high correction data has a specific non-zero value for all of the plurality of sensor pixels, and
the low correction data has a value of 0 for all of the plurality of sensor pixels.

6. The display apparatus of claim 1, wherein the sensor controller comprises:
a data obtainer configured to generate the fingerprint data by using electrical signals input from the respective light-receiving elements of the plurality of sensor pixels; and
a data processor configured to correct the fingerprint data by using the compensation coefficient to calculate the correction data.

7. The display apparatus of claim 6, wherein the sensor controller further comprises a fingerprint detector configured to detect a user's fingerprint based on the correction data.

8. The display apparatus of claim 6, wherein the compensation coefficient is a value calculated using high sensor data measured for each sensor pixel in a bright environment and low sensor data measured for each sensor pixel in a dark environment.

9. The display apparatus of claim 8, wherein, a value obtained by subtracting the low sensor data from the high sensor data is referred to as variation data, and the compensation coefficient of a specific sensor pixel among the plurality of sensor pixels is a value obtained by dividing an average value of respective variation data of the plurality of sensor pixels by the variation data of the specific sensor pixel.

10. The display apparatus of claim 8, wherein
the data processor is configured to calculate the correction data by using the compensation coefficient and a specific function, and
the specific function obtains the correction data by multiplying a value obtained by subtracting the low sensor data from the fingerprint data by the compensation coefficient.

11. A fingerprint detecting method using a display apparatus including a plurality of display pixels in which light-emitting elements are arranged, and a plurality of sensor pixels in which light-receiving elements are arranged, the fingerprint detecting method comprising:
calculating, by the display apparatus, a compensation coefficient for each of respective locations of the plurality of sensor pixels;
storing, by the display apparatus, the compensation coefficient in a memory;
generating, by the display apparatus, fingerprint data for each of the plurality of sensor pixels in a use mode; and
correcting, by the display apparatus, the fingerprint data by using the compensation coefficient to calculate correction data for each of the respective locations of the plurality of sensor pixels.

12. The fingerprint detecting method of claim 11, wherein
calculating, by the display apparatus, the compensation coefficient and the storing of the compensation coefficient in the memory comprises obtaining high sensor data for a location of each of the plurality of sensor pixels in a first inspection mode and obtaining low sensor data for each of the respective locations of the plurality of sensor pixels in a second inspection mode, and
in the first inspection mode, an inspection is performed in a bright environment, and, in the second inspection mode, an inspection is performed in a dark environment.

13. The fingerprint detecting method of claim 12, wherein the high sensor data is measured with a reflector being placed on the display apparatus, which is to be inspected, and green light being turned on.

14. The fingerprint detecting method of claim 12, wherein the low sensor data is measured with a light-absorbing plate or a black box being placed on the display apparatus, which is to be inspected, and external light being blocked.

15. The fingerprint detecting method of claim 12, wherein
the high sensor data is an average value of pieces of valid data excluding pieces of mis-measurement data that are outside an allowable range, after taking multiple pictures of the display apparatus, which is to be inspected, in the first inspection mode, and
the low sensor data is the average value of the pieces of the valid data excluding the pieces of mis-measurement data that are outside the allowable range, after taking multiple pictures of the display apparatus, which is to be inspected, in the second inspection mode.

16. The fingerprint detecting method of claim 12, wherein calculating, by the display apparatus, the compensation coefficient further comprises:
calculating variation data by subtracting the low sensor data from the high sensor data, for each of the respective locations of the plurality of sensor pixels; and
calculating an average value of pieces of variation data of all of the plurality of sensor pixels.

17. The fingerprint detecting method of claim 16, wherein calculating, by the display apparatus, the compensation coefficient further comprises dividing the average value of the variation data by the variation data of each of the plurality of sensor pixels to calculate the compensation coefficient of each of the plurality of sensor pixels.

18. The fingerprint detecting method of claim 12, wherein
calculating the correction data comprises correcting the fingerprint data by using the compensation coefficient and a specific function, and
the specific function obtains the correction data by multiplying a value obtained by subtracting the low sensor data from the fingerprint data by the compensation coefficient.

19. The fingerprint detecting method of claim 11, wherein
the fingerprint data includes high fingerprint data corresponding to valleys of a user's fingerprint, and low fingerprint data, which is data about ridges of the user's fingerprint,
the correction data includes high correction data obtained by correcting the high fingerprint data, and low correction data obtained by correcting the low fingerprint data,
the high fingerprint data and the low fingerprint data have random values for each of the respective locations of the plurality of sensor pixels, and
each of the high correction data and the low correction data have a constant value in all of the plurality of sensor pixels.

20. The fingerprint detecting method of claim 11, further comprising detecting a user's fingerprint according to the correction data.
